(19) United States
(12) Patent Application Publication
(10) Pub. No.: US 2024/0427998 A1
(43) Pub. Date: Dec. 26, 2024

(54) CONTEXTUAL QUERY GENERATION

(71) Applicant: Adobe Inc., San Jose, CA (US)

(72) Inventors: Haoliang Wang, Sunnyvale, CA (US); Tong Yu, Fremont, CA (US); Sungchul Kim, San Jose, CA (US); Ruiyi Zhang, San Jose, CA (US); Paiheng Xu, Greenbelt, MD (US); Junda Wu, Long Island City, NY (US); Handong Zhao, Cupertino, CA (US); Ani Nenkova, Philadelphia, PA (US)

(73) Assignee: Adobe Inc., San Jose, CA (US)

(21) Appl. No.: 18/339,694

(22) Filed: Jun. 22, 2023

(51) Int. Cl. G06F 40/30; G06N 5/04

(52) U.S. Cl. CPC G06F 40/30; G06N 5/04

(57) ABSTRACT

Contextual query generation techniques are described that enable generation of a contextual query for output to a question-answering (QA) model. A content processing system, for instance, configures a language model using in-context learning to generate queries based on semantic contexts of input documents, e.g., based on one or more linguistic cues from text of the input documents. The content processing system receives an input that includes a document having text and a reference query. The content processing system leverages the language model to generate a contextual query based on a semantic context of the text of the document and the reference query. The content processing system then outputs the contextual query and the document to a QA model. Using the QA model, the content processing system generates a response as an answer to the contextual query based on the contextual query and the document.

### BACKGROUND

Natural language processing (NLP) techniques are often used for a variety of tasks such as text understanding, speech recognition, text generation, etc. For example, question answering (QA) models are a subset of NLP machine learning models that receive questions in a natural language format and attempt to provide relevant answers. Because of their ability to quickly process inputs and analyze large bodies of text, QA models are frequently used for information retrieval tasks, e.g., retrieving relevant passages from a known knowledge source that contains an answer to a given question. However, conventional QA models are trained using supervised learning with large sets of domain specific training data, which is not readily available and computationally demanding to generate. Accordingly, QA models are limited by availability of labeled training data and perform poorly when used in “unfamiliar” domains.

### SUMMARY

Techniques for contextual query generation are described. In an example, a computing device implements a content processing system to configure a language model using in-context learning to generate queries based on semantic contexts of input documents, e.g., based on one or more linguistic cues from text of the input documents. The content processing system then receives an input that includes a text-based document and a reference query. The reference query represents a request to extract information from the document, e.g., what a user of the computing device “wants to know.” The content processing system leverages the language model to generate a contextual query based on a semantic context of text from the document as well as the reference query. The contextual query is a paraphrased version of the reference query that is configured to extract one or more key terms from the document. The content processing system then outputs the contextual query and the document to a question answering (QA) model. Using the QA model, the content processing system generates a response as an answer to the contextual query. Accordingly, the techniques described herein provide a modality to extract key information efficiently and accurately from documents.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the contextual query generation techniques described herein.

FIG. 2 depicts a system in an example implementation showing operation of an extraction module in greater detail.

FIG. 3 depicts an example of a sample set of demonstrations usable for in-context learning to condition a language model.

FIG. 4a depicts an example of generation of a contextual query based on an input document and a reference query using a language model.

FIG. 4b depicts an example of generating a response to a contextual query based on the contextual query and an input document.

FIG. 5 depicts an example of a comparison between generation of a response using a generic query and a contextual query.

FIG. 6 depicts an example of an additional comparison between generation of a response using a generic query and a contextual query.

FIG. 7 is a flow diagram depicting an algorithm as a step-by-step procedure in an example implementation that is performable by a processing device to generate a contextual query for output to a QA model.

FIG. 8 illustrates an example system including various components of an example device that can be implemented as any type of computing device as described and/or utilized with reference to FIGS. 1-7 to implement embodiments of the techniques described herein.

### DETAILED DESCRIPTION

### Overview

Question answering (QA) models are a subset of natural language processing models that are designed to understand questions that are structured in natural language, e.g., a text input from a user, and provide relevant answers to the questions. QA models support efficient information retrieval, improved user experiences, automation of routine tasks, and decision-making across various domains, making them valuable tools in the field of natural language processing. Training QA models typically involves use of large amounts of labeled training data in a supervised learning process to teach the QA model to generate responses.

However, acquiring domain-specific training data is costly and time-consuming, which makes it challenging to develop domain-specific QA models. For instance, domain specific information evolves constantly, and collection of adequate training data is not practical in a variety of real-world contexts. Conventional QA models also struggle to provide accurate responses related to input documents that are “noisy” or include extraneous/domain-specific information and are further limited by a quality of the prompt that they are provided. For instance, a QA model that is provided with a generic query will frequently “miss” relevant information or generate incorrect responses.

Accordingly, techniques and systems for contextual query generation are described that overcome these technical challenges and limitations to generate improved queries that are based on a context of an input document. Rather than retrain a QA model using supervised learning on a domain-by-domain basis, which would involve vast amounts of annotated training data, the techniques described herein leverage a pretrained large language model that is conditioned using in-context learning to generate context specific queries, e.g., a query to provide to a QA model that is based on a semantic context of a particular document. In this way, the techniques described herein support generation of contextual queries that ask the “right questions” to the QA model to get the “right answers.”

Consider an example in which a user reviews a document from a particular domain to extract relevant content. Rather than manually search the document to obtain the relevant information, which is time consuming and subject to error, the user leverages a QA model to obtain information about the document such as by “asking” the QA model questions about the document. However, in this example the QA model is “unfamiliar” with the particular domain, e.g., the QA model has not been trained on training data relevant to the particular domain. Further, the document is “noisy” and includes nuanced information that involves background knowledge to understand. Accordingly, the QA model is subject to errors and generates incomplete or inaccurate answers using conventional approaches.

Accordingly, using the techniques described herein a processing device implements a content processing system to condition a language model using one or more “demonstrations.” In this example, the content processing system adapts the language model using a minimally supervised process such as in-context learning. For instance, the language model is pretrained to understand general natural language patterns, concepts, grammar, etc. The content processing system is then operable to use the demonstrations to “show” the language model how to generate queries based on a semantic context of input documents, e.g., without having to modify parameters of the language model which conserves computational resources relative to conventional techniques.

Generally, the demonstrations include a text snippet (e.g., a document), a reference query, and a training contextual query. The reference query represents a request to extract information from the input document, e.g., what the user “wants to know.” The training contextual query is a paraphrased version of the reference query based on a semantic context of the text snippet. For instance, the training contextual query is configured such that input of the training contextual query to a QA model will generate a desired response. Using the in-context learning process, the language model is conditioned using a relatively small number of demonstrations, e.g., three or less, which increases accuracy and overcomes conventional techniques that are hindered by a lack of training data.

The content processing system further receives an input that includes a document having text, e.g., the document that the user is reviewing, and a reference query such as the reference query from the demonstrations. In this example, the reference query includes the text “what is the user impact?” The content processing system leverages the language model, conditioned on the demonstrations, to generate a contextual query that is based on a semantic context of the text of the document and the reference query. Continuing with the above example, the text of the input document describes a client experience with a software product. For instance, a relevant excerpt of the document describes that “ . . . agents in the Bangalore location were experiencing issues with logging into the chat application and replying to customer chat messages.” Accordingly, the language model generates the contextual query as a paraphrased version of the reference question that is based on linguistic cues from the text of the input document, e.g., “what have users experienced?”

The content processing system then outputs the contextual query and the input document to a QA model, e.g., a ROBERTa Model, such as described Liu, et. al., ROBERTa: A Robustly Optimized BERT Pretraining Approach. arXiv: 1907.11692 (2019), that is configured for a question answering task. The content processing system leverages the QA model to generate a response as an answer to the contextual query based on the contextual query and the input document. Because the contextual query is based on a semantic context of the input document itself, the QA model is able to extract relevant information, e.g., one or more key terms that correspond to a “correct” answer, from the input document.

For example, input of the reference query (e.g., “what is the user impact?”) to the QA model generates an incomplete response such as “agents were impacted by this issue” which is of little practical value for the user. However, input of the contextual query (e.g., “what have users experienced?”) to the QA model results in a correct and informative response such as “users have experienced issues with logging into the chat application and replying to customer chat messages.” Accordingly, the techniques described herein support increased accuracy and performance of a QA model by generating context specific queries based on linguistic cues of input documents. These techniques overcome the limitations of conventional techniques that fail to provide accurate responses for noisy documents and/or documents from an unfamiliar domain. Further discussion of these and other examples and advantages are included in the following sections and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

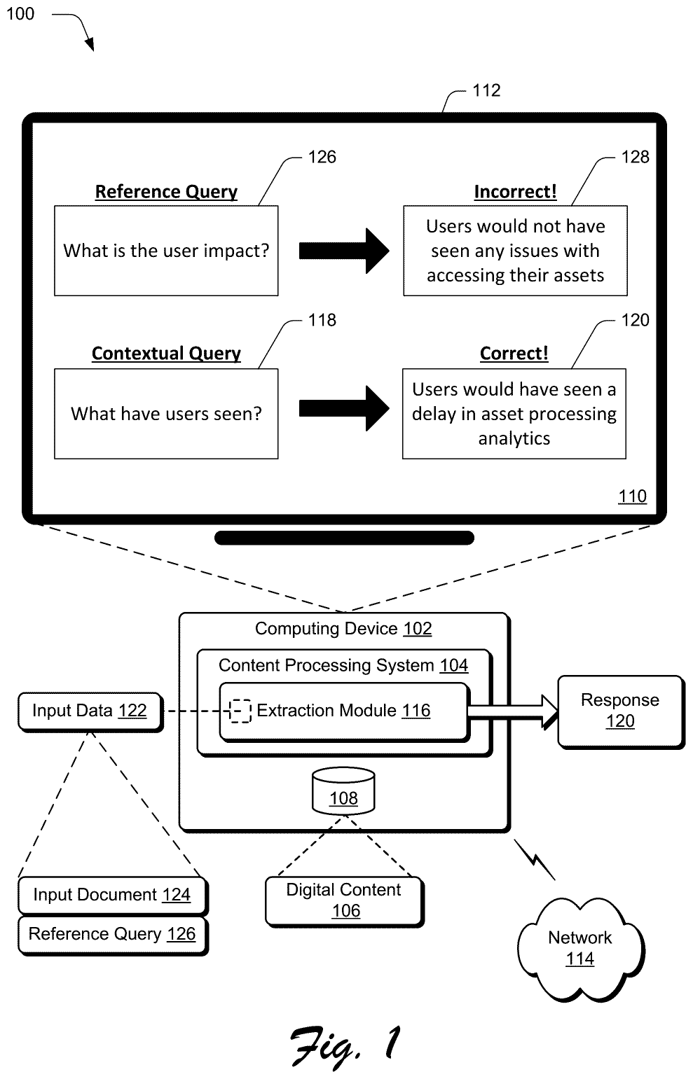

FIG. 1 is an illustration of a digital medium environment 100 in an example implementation that is operable to employ the contextual query generation techniques described herein. The illustrated environment 100 includes a computing device 102, which is configurable in a variety of ways.

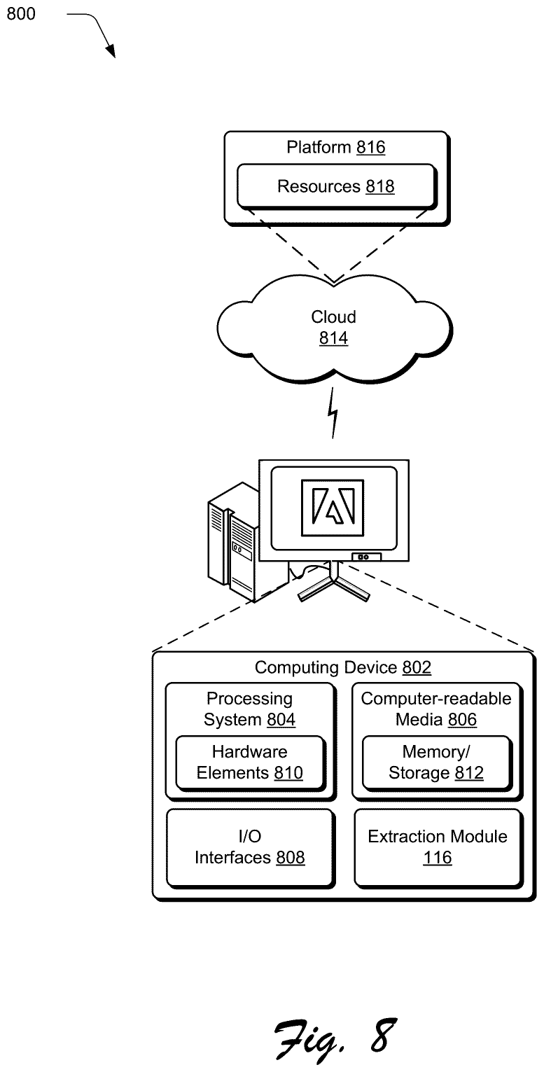

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform and/or cause operations “over the cloud” as described in FIG. 8.

The computing device 102 is illustrated as including a content processing system 104. The content processing system 104 is implemented at least partially in hardware of the computing device 102 to process and transform digital content 106, which is illustrated as maintained in storage 108 of the computing device 102. Such processing includes creation of the digital content 106, modification of the digital content 106, extraction of one or more portions of the digital content 106, and rendering of the digital content 106 in a user interface 110 for output, e.g., by a display device 112. Although illustrated as implemented locally at the computing device 102, functionality of the content processing system 104 is also configurable in whole or in part via functionality available via the network 114, such as part of a web service or “in the cloud.”

An example of functionality incorporated by the content processing system 104 to process the digital content 106 is illustrated as an extraction module 116. The extraction module 116 is configured to generate a contextual query 118, such as a question for input to a QA model to generate a response 120 to the contextual query 118. For instance, in the illustrated example the extraction module 116 receives input data 122 that includes an input document 124 and a reference query 126. As further described below, the input document 124 is configurable in a variety of ways and/or file formats, such as plain text format, hypertext markup language (HTML), portable document format (PDF), etc. While not illustrated, in this example the input document 124 represents a report (e.g., a report generated by a site reliability engineer to support technical and/or system operations) that includes text describing a system issue with an application to access various assets.

Generally, the reference query 126 represents what a user of the computing device 102 “wants to know.” For instance, the reference query 126 represents a generic question about content from the input document 124. In the illustrated example, the reference query 126 includes the text “what is the user impact?” However, provision of the reference query 126 to the QA model of the extraction module 116 results in an incorrect response 128, e.g., “Users would not have seen any issues with accessing their assets.”

Accordingly, the extraction module 116 is configured to generate a contextual query 118 that is based on the text of the input document 124 and the reference query 126. For instance, the extraction module 116 includes a large language model that is configurable to generate contextual queries based on a semantic context of the input document 124. In various examples, the contextual query 118 is based on linguistic cues from the text of the input document 124, one or more key terms extracted from the input document 124, a particular format and/or structure of the input document 124, domain-specific text strings included in the input document 124, etc. Further, in this example the large language model is configured using in-context learning by conditioning with three or less “demonstrations” to guide the large language model during inferencing.

The extraction module 116 is operable to output the contextual query 118 to the QA model. Based on the contextual query 118 and the input document 124, the extraction module 116 leverages the QA model to generate a response 120 as an answer to the contextual query 118. By generating contextual queries 118 that are based on semantic contexts of the input documents 124 themselves, the extraction module 116 is able to generate accurate responses 120 for a variety of input documents and provides a modality to efficiently locate relevant information within documents. This overcomes the technical limitations and challenges of conventional techniques, which utilize large amounts of training data to configure QA models for domain specific applications and fail to provide accurate responses to unfamiliar and/or noisy input documents. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Contextual Query Generation

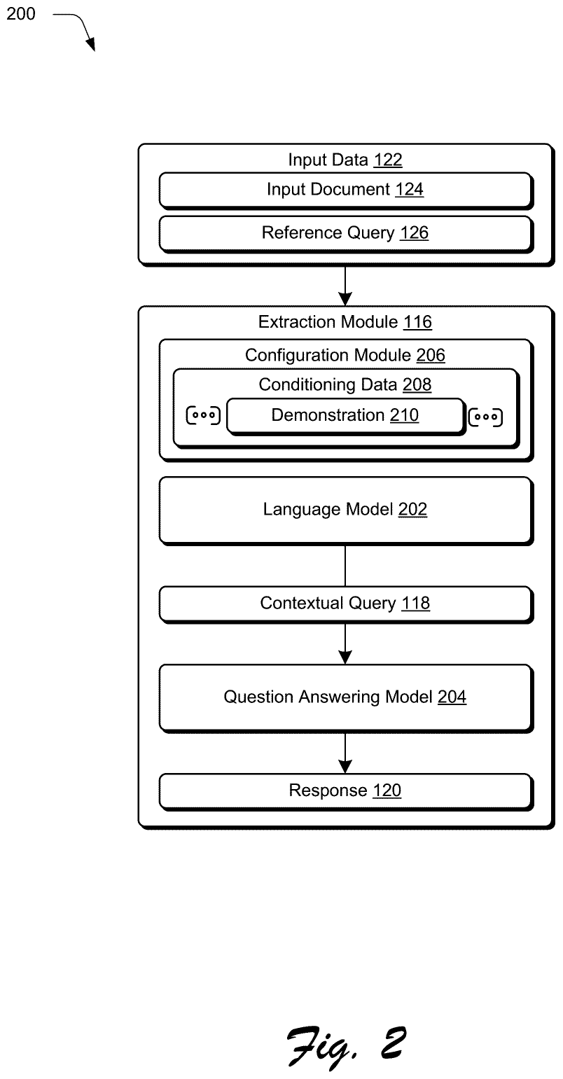

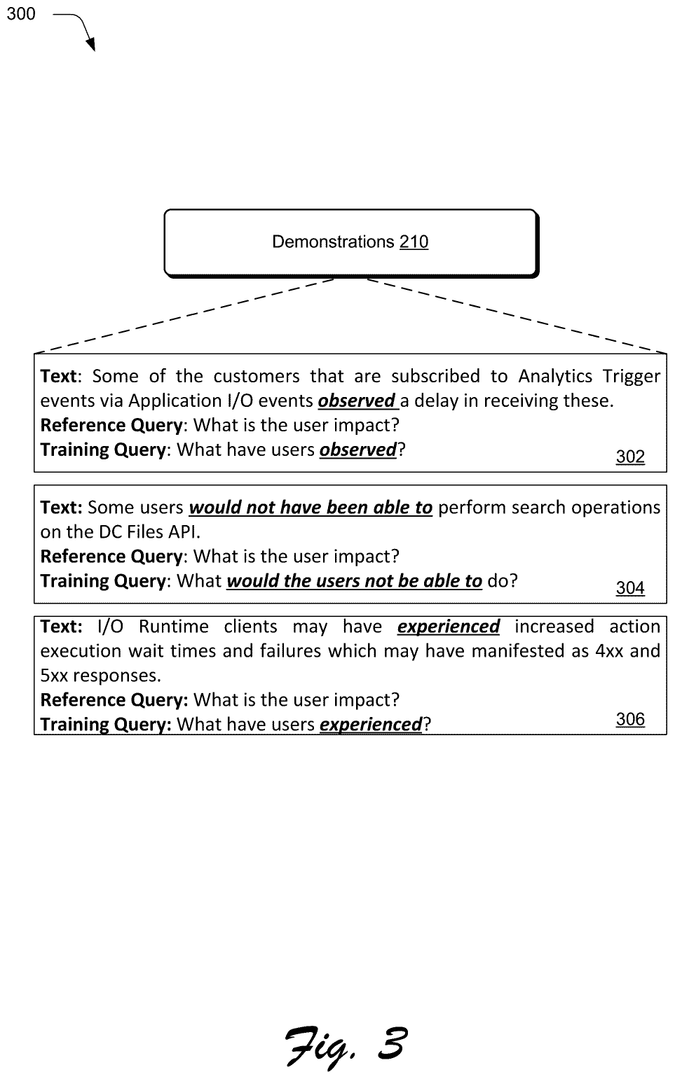

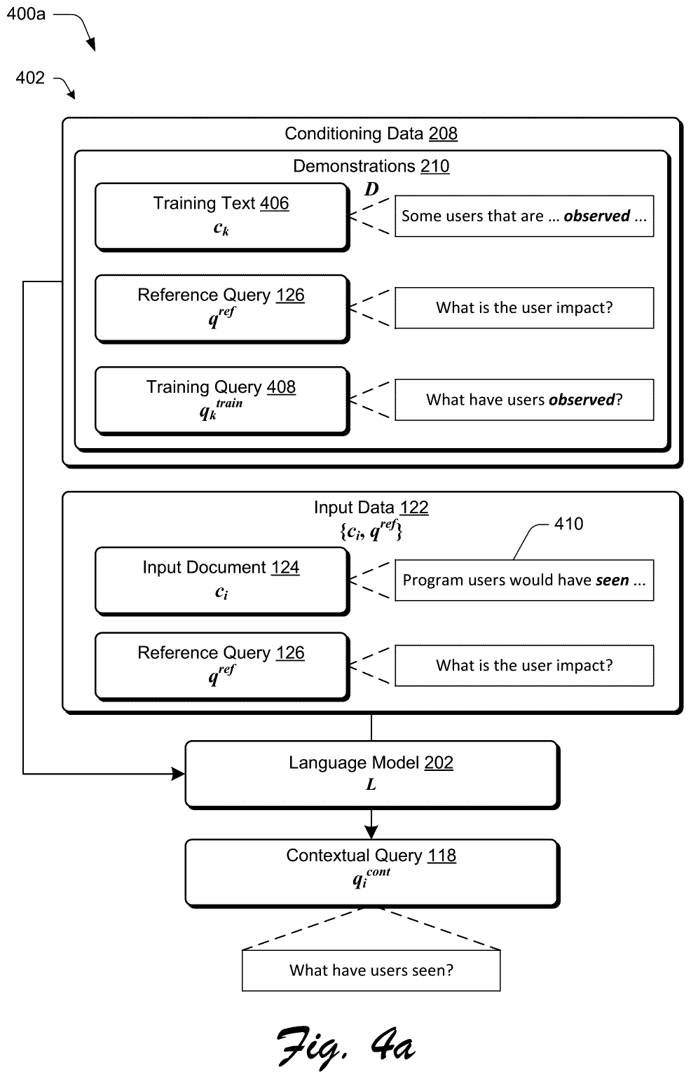

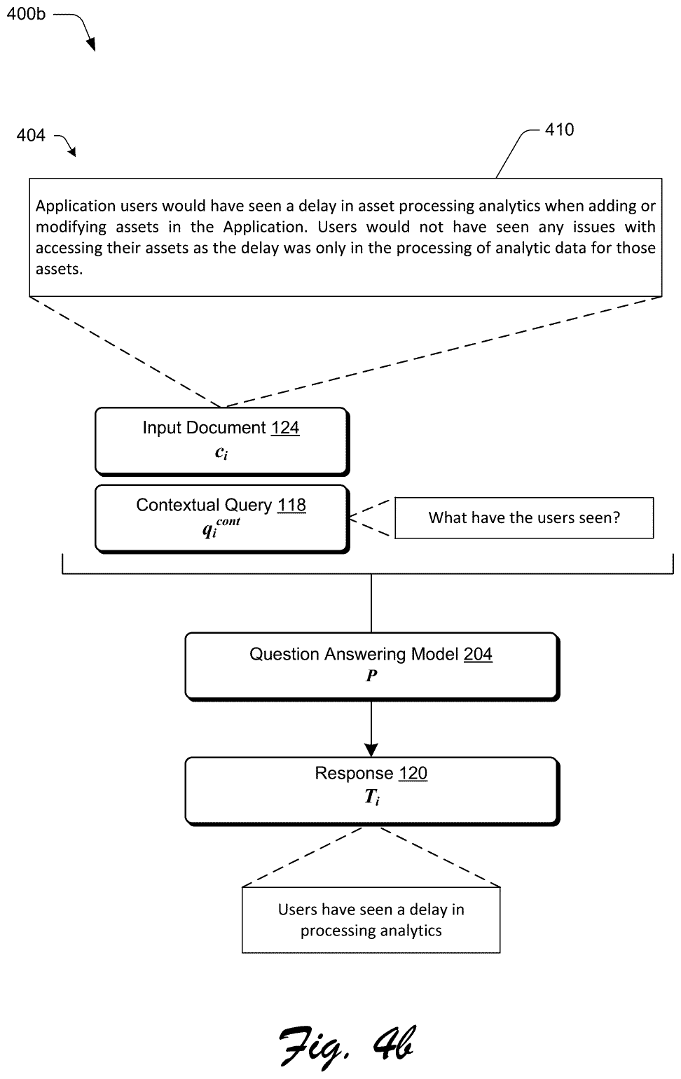

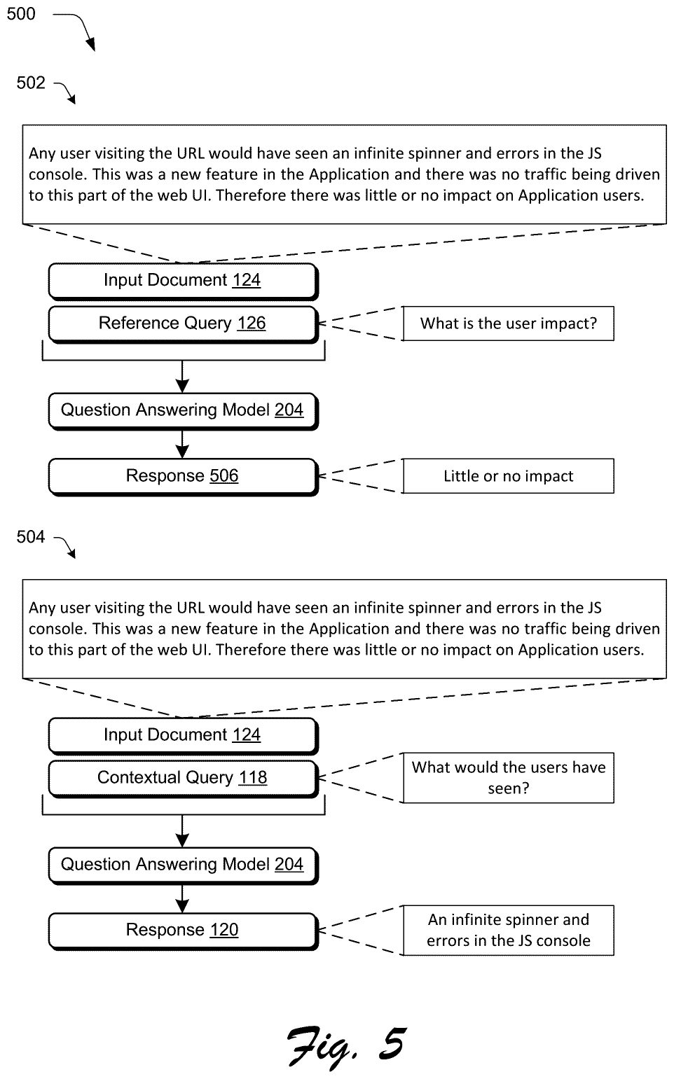

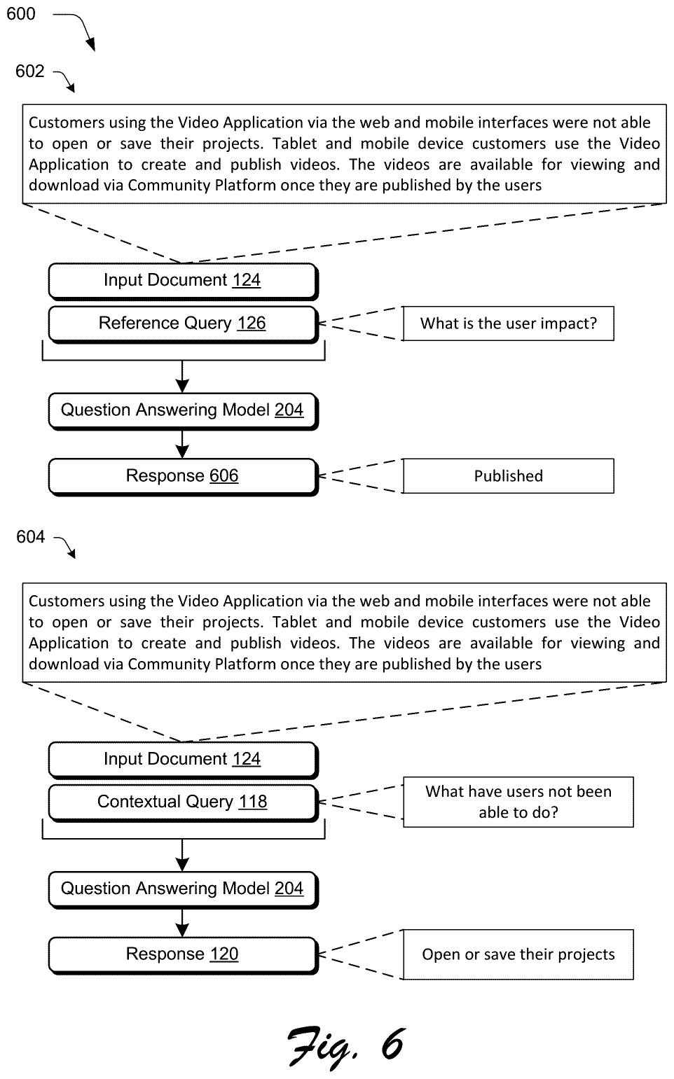

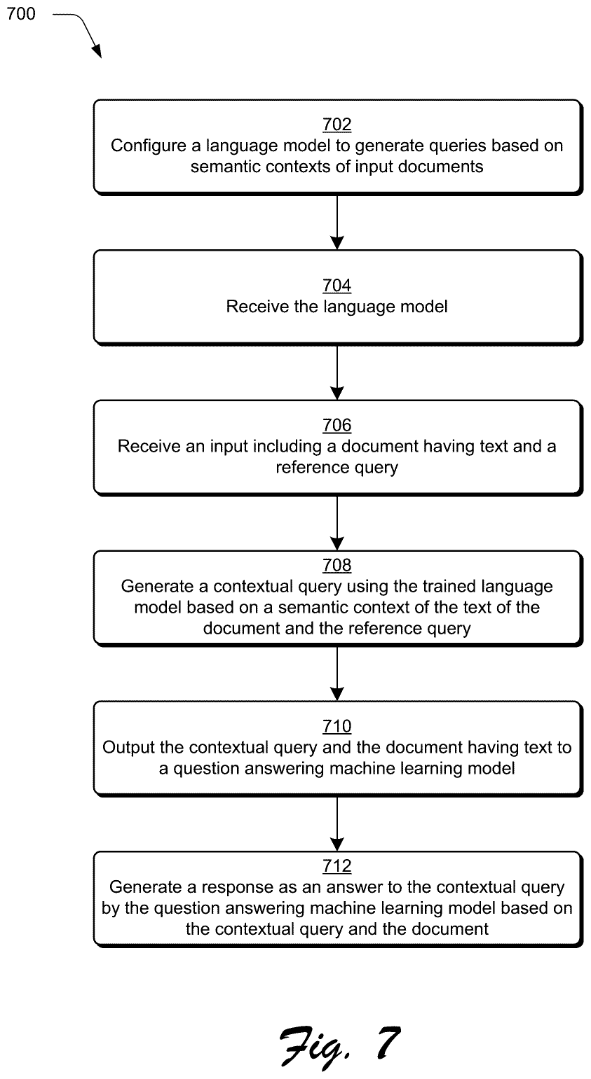

FIG. 2 depicts a system 200 in an example implementation showing operation of an extraction module 116 of FIG. 1 in greater detail. FIG. 3 depicts an example 300 of a sample set of demonstrations usable in in-context learning to condition a language model. FIG. 4a depicts an example 400a of generation of a contextual query based on an input document and a reference query using a language model. FIG. 4b depicts an example 400b of generating a response to a contextual query based on the contextual query and an input document. FIG. 5 depicts an example 500 of a comparison between generation of a response using a generic query and a contextual query. FIG. 6 depicts an example 600 of an additional comparison between generation of a response using a generic query and a contextual query. FIG. 7 is a flow diagram depicting an algorithm as a step-by-step procedure 700 in an example implementation that is performable by a processing device to generate a contextual query for output to a QA model.

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-6 and in parallel to the procedure 700 of FIG. 7.

FIG. 2 depicts a system 200 in an example implementation showing operation of an extraction module 116 in greater detail. Generally, the extraction module 116 is operable to generate a contextual query 118 that is based on a semantic context of an input document 124 and a reference query 126 using a trained language model 202. Once the contextual query 118 is generated, the extraction module 116 leverages a QA model 204 to generate a response 120 as an answer to the contextual query 118.

In an example to do so, the extraction module 116 includes a configuration module 206 that is operable to configure a language model 202 to generate queries based on semantic contexts of input documents (block 702). The language model 202, for instance, is a large language model that is able to understand and generate human-like language. In one example, the language model is a GPT3 model such as described by Brown, et al. Language models are few-shot learners. Advances in neural information processing systems, 33:1877-1901, 2020. This is by way of example and not limitation, and a variety of suitable large language models are considered.

In various embodiments, the configuration module 206 trains the language model using unsupervised learning, minimally supervised learning, weakly supervised learning, and/or low-shot learning. For example, the configuration module 206 configures the language model 202 using a minimally supervised process that includes in-context learning. In an example of in-context learning, the language model 202 is partially or wholly pre-trained, such as pre-trained using unsupervised learning to learn general natural language patterns, concepts, grammar, etc. The configuration module 206 is then operable to condition the language model 202 on conditioning data 208 using in-context learning for task specific and/or domain specific applications, such as without updating parameters of the model itself. In this example, the conditioning data 208 includes one or more demonstrations 210 that the configuration module 206 leverages to guide the language model 202 to generate contextual queries 118 based on contexts of input documents 124.

Generally, the demonstrations 210 include context specific information and are used by the configuration module 206 to condition the language model 202 to consider a context when generating queries, e.g., to “adapt” the wording of the reference query based on a semantic context of the input document 124. Each demonstration 210 is an input-label tuple that includes a “context” such as a text snippet (e.g., one or more documents, paragraphs, sentences, etc.), a reference query 126, and a training contextual query. The reference query 126 represents a generic request to extract information from the text snippet. The training contextual query represents a paraphrased version of the reference query 126 based on a context of the text snippet. For instance, the training contextual query is configured such that input of the training contextual query to the QA model 204 will generate a desired response. In an example, the training contextual query is based on linguistic cues, e.g., one or more key terms, of the text snippets.

In some examples, the demonstrations 210 are curated by a user of the computing device 102, e.g., generated manually. Additionally or alternatively, the demonstrations 210 are generated automatically and without user intervention by the configuration module 206. In one example, a plurality of sets of demonstrations 210 are maintained, such as in storage 108. A first set of demonstrations 210, for example, corresponds to a first reference query 126, a second set of demonstrations 210 corresponds to a second reference query 126, and so forth. Accordingly, the extraction module 116 is able to access a variety of sets of demonstrations 210 to configure the language model 202 to generate contextual queries 118 based on a variety of reference queries 126. In various examples, the configuration module 206 uses relatively few demonstrations 210 (e.g., three or less demonstrations 210) to teach the language model 202 using in-context learning, which conserves computational resources and overcomes conventional limitations related to a lack of annotated training data.

FIG. 3 depicts an example 300 of a sample set of demonstrations 210 usable for in-context learning, such as to condition a language model 202. As illustrated, the set of demonstrations 210 includes a first demonstration 302, a second demonstration 304, and a third demonstration 306. In this example, each demonstration 210 includes a text snippet, a reference query 126, and a training contextual query. For instance, the first demonstration 302 includes a text snippet with text that describes “Some of the customers that are subscribed to Analytics Trigger events via Application I/O events observed a delay in receiving these.” The reference query 126 is “What is the user impact?” and the training contextual query is a paraphrased version of the reference query 126 based on a context of the text snippet, e.g., “What have users observed?” Thus, the training contextual query for the first demonstration 302 includes one or more key terms from the text snippet such as the word “observed” which is emphasized in the illustrated example 300.

The reference queries 126 for the first demonstration 302, the second demonstration 304, and the third demonstration 306 are fixed, e.g., “What is the user impact?” However, the training contextual queries vary for each demonstration 210 based on a semantic context of the corresponding text snippet. As illustrated, the training contextual query for the second demonstration 304 is “what would the user not be able to do?” which corresponds to language used in the text snippet for the second demonstration 304. Similarly, the training contextual query for the third demonstration 306 is “what have users experienced?” which corresponds to language used in the text snippet for the third demonstration 306 as illustrated with emphasis added. In this example, the configuration module 206 is able to adapt the language model 202 using in-context learning to generate contextual queries 118 using relatively few demonstrations 210 (e.g., the first demonstration 302, the second demonstration 304, and the third demonstration 306) which overcomes the limitations of conventional techniques that are limited by availability of domain specific training data.

The extraction module 116 is operable to receive the language model 202 (block 704). The language model 202, for instance, is configured to generate queries based on semantic contexts of input documents as described above. In one or more examples, the extraction module 116 receives the language model 202 as preconfigured, e.g., conditioned based on various demonstrations 210. The extraction module 116 is also configured to further refine/configure the language model 202, e.g., by using in-context learning in accordance with the techniques described above.

The extraction module 116 also receives input data 122 that includes an input document 124 having text and a reference query 126 (block 706). The text of the input document 124 can include one or more words, strings, sentences, paragraphs, pages, etc. In various examples, the text of the input document 124 includes one or more key terms, e.g., words and/or phrases that are relevant to a particular reference query 126 and/or a contextual query 118. In an example, the key terms of the text represent a “correct” answer to a query provided to the QA model 204. The input document 124 is configurable in a variety of styles and/or file formats, e.g., plain text format, hypertext markup language (HTML), portable document format (PDF), comma-separated values (CSV), extensible markup language (XML), rich text format (RTF), document xml-based (DOCX), text (TXT), etc. In one example, the input document 124 represents a transcript of a conversation. Alternatively or additionally, the input document 124 represents a domain specific document, e.g., a “CSO” report that includes site reliability engineering and/or software engineering concepts, a root cause analysis (RCA) report that describes various aspects of a technical incident/outage, etc. In various examples, the input document 124 includes a particular structure and/or format. For instance, the input document 124 has a structure defined by one or more headers, subheaders, body text, etc.

The reference query 126 generally represents a request to extract information related to the input document 124, e.g., what a user “wants to know” about the input document 124. However, because the reference query 126 is not based on the input document 124, input of the reference query 126 to a QA model generates inaccurate or incorrect results. In various examples, the reference query 126 is the same as the reference query 126 in the one or more demonstrations 210. The extraction module 116 is operable to receive the reference query 126 in a variety of formats, e.g., as text input, voice input, using handwriting and/or touchpad recognition techniques, text-prediction/autocomplete, gesture recognition, etc.

Based on the input document 124 and the reference query 126, the extraction module 116 generates a contextual query 118 using the language model 202 based on a semantic context of the text of the input document 124 and the reference query 126 (block 708). Generally, the contextual query 118 is configured to extract key terms from the input document 124 when input to a question answering machine learning model, such as the QA model 204. For example, the contextual query 118 represents a paraphrased version of the reference query 126 based on one or more linguistic cues from the text of the input document 124.

Generally, the semantic context of the text pertains to a meaning and/or understanding of the words, phrases, sentences, and/or tokens (e.g., units of text that the language model 202 is able to process) of the input document 124 based on various linguistic cues. In some examples, the semantic context of the text includes syntactic cues such as a syntax/arrangement of words, phrases, or tokens in one or more sentences of the input document 124. Accordingly, the language model 202 is configured to generate the contextual query 118 based on a syntactic structure of the input document 124. For instance, the contextual query 118 is based on one or more syntactic relationships between different elements (e.g., tokens, words, sentences, paragraphs, etc.) of the input document 124.

Additionally or alternatively, the semantic context includes structural properties and/or format features of the input document 124, e.g., one or more headers, subheaders, paragraphs, bullets, lists, typographical features (bold, italics, underline, strikethrough, etc.), presence of tables and/or graphics, etc. In some examples, the semantic context includes lexical cues, such as meanings of individual words/text strings, lexical relationships, semantic roles, etc. For instance, the semantic context includes one or more domain specific text strings that represent key terms of the input document 124. Accordingly, in various examples the contextual query 118 is generated to include one or more text strings (e.g., particular key terms) and/or one or more tokens extracted from the input document 124. In this way, the extraction module 116 is able to generate the contextual query 118 based on a variety of features of the input document 124 and instructs the QA model 204 to accurately generate a response 120.

Further, the extraction module 116 is operable to configure the contextual query 118 in a variety of ways, such as a natural language “question”, a text-based request, variable length prompts, structured data, one or more sentence fragments, key words, and/or phrases to direct a QA model, etc. In an example in which text snippets of the demonstrations 210 include a particular structure, the extraction module 116 is operable to transform the text of the input document 124 to match the particular structure of the text snippets of the demonstrations 210 as part of generating the contextual query 118. In this way, the extraction module 116 is able to increase accuracy of subsequently generated responses 120 by a QA model.

In one example, the input document 124 includes a transcript, such as from an ongoing meeting, online video conference, phone conversation, etc. The extraction module 116 is operable to generate a contextual query 118 based on the transcript in real time. For instance, as the transcript is updated (e.g., as the meeting progresses) the extraction module 116 is operable to update the contextual query 118. In this way, the techniques described herein support iterative generation of contextual query 118 in real time that is usable by a user to extract information from an ongoing meeting.

In some examples, once the contextual query 118 is generated, the extraction module 116 outputs the contextual query 118 in a user interface 110 of the computing device 102, such as via the display device 112. Alternatively or additionally, the extraction module 116 outputs the contextual query 118 and the input document 124 to the QA model 204 (block 710). Generally, the QA model 204 is a question answering machine learning model that is configured to receive a query as input and generate an answer to the query for output. In one example, the QA model 204 is a RoBERTa Model configured for a question-answering task such as such as described Liu, et. al., ROBERTa: A Robustly Optimized BERT Pretraining Approach. arXiv: 1907.11692 (2019). This is by way of example and not limitation, and a variety of suitable models and/or datasets are considered. In some examples, the QA model 204 is fine-tuned and/or trained on an extractive QA dataset such as a SQUAQ 2.0 dataset such as described by P. Rajpurkar, et al. Know what you don't know: Unanswerable questions for SQUAD. In Proceedings of the 56th Annual Meeting of the Association for Computational Linguistics, vol. 2, 784-789, (2018).

Accordingly, the extraction module 116 generates a response 120 as an answer to the contextual query 118 by the QA model 204 based on the contextual query 118 and the input document 124 (block 712). Generally, the response 120 based on the contextual query 118 includes one or more key terms extracted from the input document 124. The key terms, for instance, are associated with a “correct” answer to the contextual query 118. However, a response generated by the QA model 204 based on the reference query 126 does not include the one or more key terms, e.g., the response based on the reference query 126 is inaccurate and/or incomplete. In this way, the techniques described herein support increased accuracy and performance of a QA model by generating context specific queries based on linguistic cues of input documents, which overcomes the limitations of conventional techniques that fail to provide accurate responses for noisy documents and/or documents from an unfamiliar domain.

FIGS. 4a and 4b depict examples 400a and 400b of generating a contextual query 118 and a response 120 as an answer to the contextual query 118 in a first stage 402 and a second stage 404. As depicted in first stage 402, a language model 202, represented as L, is conditioned on one or more demonstrations 210, represented in the illustrated example as D, to generate queries based on input documents, such as for input to a QA model P. In this example, each demonstration 210 is a triple that includes training text 406, a reference query 126, and a training query 408. The training text 406, denoted as cₖ, represents a text snippet from a context K, such as a paragraph extracted from a corpus of text from a particular domain. As illustrated, the training text 406 includes an excerpt of text that describes “some of the users that are . . . observed . . . .” While not shown in the illustrated example, the training text 406 includes additional text that is not depicted.

The reference query 126, which is represented as q^{ref}, represents a general question about the training text 406. In this example, the reference query 126 is “what is the user impact?” The training query 408 (e.g., a training contextual query) is denoted as qₖ^{train} and represents a paraphrased version of the reference query 126 that is based on linguistic cues from the training text 406. As illustrated, the training query 408 is adapted from the reference query 126 to a context specific question, e.g., “what have the users observed?” Emphasis is added in the illustrated example to depict that the training query 408 and the training text 406 include the word “observed”.

Accordingly, the training queries 408 are configured to extract one or more key terms Tₖ from the training text 406 when input to the QA model 204. In other words, the demonstrations 210 are configured such that P(Tₖ|cₖ, qₖ^{cont})>P(Tₖ|cₖ, q^{ref}). Further, by utilizing an in-context learning scheme, the extraction module 116 utilizes relatively few demonstrations 210 (e.g., three or fewer) to teach the language model 202, which conserves computational resources and overcomes conventional limitations related to a lack of annotated training data.

The language model 202 is operable to receive input data 122 that includes an input document 124 denoted as cᵢ and the reference query 126. In the illustrated example, an excerpt 410 of the input document 124 is from the particular domain and describes a summary of a system issue for an application. The excerpt 410 is depicted in full in the second stage 404 of FIG. 4b. Further, the reference query 126 provided to the language model 202 is the same as the reference query 126 used as part of the conditioning data 208. Based on the reference query 126 and a semantic context of the excerpt 410, the language model 202 is operable to generate a contextual query 118, which is represented as qᵢ^{cont} in the illustrated example. The contextual query 118 includes the text “what have users seen?”. Thus, the contextual query 118 is configured to guide the QA model 204 to extract key terms Tᵢ from the input document 124.

In the second stage 404, the extraction module 116 leverages a QA model 204 to generate a response 120 that includes key terms Tᵢ, to the contextual query 118. The QA model 204, for instance, generates the response 120 as an answer to the contextual query 118 based on the contextual query 118 and the input document 124. In this example, the response 120 is based on the contextual query 118 and includes one or more key terms from the excerpt 410, for instance the response 120 includes the text “users have seen a delay in processing analytics.” In this way, the techniques described herein support generation of queries for QA models that are based on a semantic context of input documents themselves, which increases the ability of the QA model 204 to extract information quickly and efficiently from a corpus of text.

FIG. 5 depicts an example 500 of a comparison between generation of a response using a generic query and a contextual query in a first stage 502 and a second stage 504. As illustrated in first stage 502, an input document 124 and a generic query, e.g., a reference query 126, are input to a QA model 204 to generate a response 506 to the reference query 126. In this example, the input document 124 includes a summary of text that describes a user issue with an application. The reference query 126 includes the text “what is the user impact?” Based on the reference query 126, the QA model 204 generates a response 506 that describes that there is “little or no impact.” In this example, the QA model 204 is misled by the word “impact” in the reference query 126. Accordingly, generic queries to the QA model 204 miss relevant information and/or generate incorrect responses.

As depicted in second stage 504, however, the QA model 204 is provided with a contextual query 118 generated in accordance with the techniques described herein. For instance, the extraction module generates a contextual query 118 based on the reference query 126 and the input document 124 using the language model 202 conditioned on one or more demonstrations. Accordingly, the contextual query 118 is configured to extract one or more key terms from the input document 124 when input to the QA model 204. In this example, the contextual query 118 is based on linguistic cues from the input document 124 and includes the text “what would the users have seen?” The QA model 204 generates a response 120 as an answer to the contextual query, e.g., “An infinite spinner and errors in the JS console.” Thus, the contextual query 118 guides the QA model 204 to the correct answer, whereas the reference query 126 misled the QA model 204. In this way, the techniques described herein support techniques to improve the accuracy of responses generated by QA models 204 that circumvent the limitations of conventional approaches that are restricted by availability of training data.

FIG. 6 depicts an example 600 of an additional comparison between generation of a response using a generic query and a contextual query in a first stage 602 and a second stage 604. As illustrated in first stage 602, an input document 124 and a generic query, e.g., a reference query 126, are input to a QA model 204 to generate a response 606 to the reference query 126. In this example, the input document 124 includes a summary of text that describes a user issue with a video application. The reference query 126 includes the text “what is the user impact?” Based on the reference query 126, the QA model 204 generates a response 606 that describes that includes the text “published.” Accordingly, the generic query to the QA model 204 generates a nonsensical response 606 that has little value to a user.

As depicted in second stage 604, however, the QA model 204 is provided with a contextual query 118 generated in accordance with the techniques described herein, e.g., based on the reference query 126 and the input document 124. In this example, the contextual query is different that the contextual query generated in first stage 502. This is because the contextual query is generated based on a semantic context of the input document 124, which differs in this example. The contextual query 118 is configured to extract one or more key terms from the input document 124. In this example, the contextual query further includes one or more key terms from the input document 124 and includes the text “what have users not been able to do?” The QA model 204 generates a response 120 as an answer to the contextual query, e.g., “Open or save their projects.” In this way, the techniques described herein support techniques to generate accurate responses, whereas generic queries are subject to errors.

### Example System and Device

FIG. 8 illustrates an example system generally at 800 that includes an example computing device 802 that is representative of one or more computing systems and/or devices that implement the various techniques described herein. This is illustrated through inclusion of the extraction module 116. The computing device 802 is configurable, for example, as a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory component and/or memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a language model configured using in-context learning to generate queries based on semantic contexts of input documents;
receiving, by the processing device, an input including a document having text and a reference query;
generating, by the processing device, a contextual query using the language model based on a semantic context of the text of the document and the reference query;
outputting, by the processing device, the contextual query and the document having text to a question answering machine learning model; and
generating, by the processing device, a response as an answer to the contextual query by the question answering machine learning model based on the contextual query and the document.

2. The method as described in claim 1, wherein the contextual query is a paraphrased version of the reference query based on one or more linguistic cues from the text of the document.

3. The method as described in claim 1, wherein the in-context learning includes using one or more demonstrations to condition the language model, each respective demonstration including a text snippet, the reference query, and a training contextual query.

4. The method as described in claim 3, wherein the in-context learning includes using three or fewer demonstrations.

5. The method as described in claim 3, wherein the text snippets of the one or more demonstrations include a particular structure and the generating the contextual query includes transforming the text of the document to match the particular structure of the text snippets of the one or more demonstrations.

6. The method as described in claim 1, wherein the language model is a GPT3 model and the question answering machine learning model is a ROBERTa model.

7. The method as described in claim 1, wherein the response includes one or more key terms extracted from the document based on the contextual query and an additional response generated by the question answering machine learning model based on the reference query does not include the one or more key terms.

8. The method as described in claim 1, wherein the semantic context includes one or more domain specific text strings that represent key terms of the document.

9. A system comprising:
a memory component; and
a processing device coupled to the memory component, the processing device to perform operations including:
receiving a language model configured to generate queries based on semantic contexts of input documents and an input that includes a document having text and a reference query;
generating a contextual query using the language model based on a semantic context of the text of the document and the reference query;
outputting the contextual query and the document having text to a question answering machine learning model; and
generating a response as an answer to the contextual query by the question answering machine learning model based on the contextual query and the document.

10. The system as described in claim 9, wherein the contextual query is a paraphrased version of the reference query that includes one or more tokens extracted from the text of the document.

11. The system as described in claim 9, wherein the response includes one or more key terms extracted from the document based on the contextual query and an additional response generated by the question answering machine learning model based on the reference query does not include the one or more key terms.

12. The system as described in claim 9, wherein the semantic context includes one or more domain specific text strings associated with key terms extracted from the document.

13. The system as described in claim 9, wherein the semantic context is based in part on a structure of the document.

14. The system as described in claim 9, wherein the language model is configured using in-context learning using one or more demonstrations to condition the language model, each respective demonstration including a text snippet, the reference query, and a training contextual query.

15. The system as described in claim 14, wherein generating the contextual query includes transforming the text of the document to match a particular structure of the text snippets of the one or more demonstrations.

16. A non-transitory computer-readable storage medium storing executable instructions, which when executed by a processing device, cause the processing device to perform operations comprising:
receiving a language model configured using in-context learning to generate queries based on semantic contexts of input documents;
receiving an input including a document having text and a reference query;
generating a contextual query using the language model based on a semantic context of the text of the document and the reference query; and
outputting the contextual query in a user interface of the processing device.

17. The non-transitory computer-readable storage medium as described in claim 16, further comprising inputting the contextual query to a question answering machine learning model to generate a response as an answer to the contextual query based on the contextual query and the document.

18. The non-transitory computer-readable storage medium as described in claim 17, wherein the contextual query is a paraphrased version of the reference query that is configured to extract one or more key terms from the document when input to the question answering machine learning model.

19. The non-transitory computer-readable storage medium as described in claim 16, wherein the in-context learning includes using three or less demonstrations to condition the language model, each respective demonstration including a text snippet, the reference query, and a training contextual query.

20. The non-transitory computer-readable storage medium as described in claim 19, wherein the text snippets of the demonstrations are extracted from a corpus of text from a particular domain and the document is from the particular domain.
